(19) United States
(12) Patent Application Publication
(10) Pub. No.: US 2014/0082066 A1
(43) Pub. Date: Mar. 20, 2014

(54) COMPUTER SYSTEM AND INFORMATION PROCESSING METHOD

(71) Applicant: Hitachi, Ltd., Tokyo (JP)

(72) Inventor: Atsuyuki Inui, Tokyo (JP)

(73) Assignee: Hitachi, Ltd., Tokyo (JP)

(21) Appl. No.: 14/115,769

(22) PCT Filed: May 6, 2011
(86) PCT No.: PCT/JP2011/060591

§ 371 Date: Nov. 5, 2013

(51) Int. Cl. H04L 29/06

(52) U.S. Cl. CPC H04L 67/42
USPC 709/203

(57) ABSTRACT

A computer system including at least one terminal, a server and a monitoring apparatus. The monitoring apparatus measures first information indicating whether or not a user is present in front of the terminal and transmits measurement results including the first information to the server. The terminal requests the server to start a job as instructed by the user and requests a progress of the job inquired by the user from the server. The server retains second information including the job requested to be started, the user who has requested the job, a count of requests for the progress of the job and the user who has requested the progress of the job, calculates an attention degree of the user for the job based on the transmitted measurement result and the second information, and determines a priority of the job requested to be started based on the calculated attention degree.

### BACKGROUND

This invention relates to a computer system, and more particularly, to a computer system for determining a priority of a job.

In general, a plurality of users share computer resources with one another in a case where the plurality of users use a client-server system that performs processing requiring much time such as mass data processing. Therefore, in order to fairly allocate limited computer resources to the respective users, the client-server system needs to schedule execution of a job instructed to be started by the users.

As a conventional method of scheduling the execution of the job, for example, Patent Literature 1 proposes a method involving sensing whether or not a user is seated by using a human sensor and executing the job instructed to be started when it is determined that the user is away, while inhibiting the execution of the job instructed to be started when it is determined that the user is seated.

Further, as the conventional method of scheduling the execution of the job, Patent Literature 2 proposes a method of dynamically changing the priority of executing the job depending on a resource amount of a computer that executes the job.

Further, as the conventional method of scheduling the execution of the job, Patent Literature 3 proposes a method involving calculating a point necessary for the job and scheduling the job depending on how much the calculated point is consumed.
Patent Literature 1: JP 2010-231814 A
Patent Literature 2: JP 2009-277041 A
Patent Literature 3: JP 2006-048275 A

### SUMMARY

However, according to Patent Literature 1, the job is controlled alternatively depending on only whether the user is seated or away, and hence it is not possible to schedule the job accurately based on a degree to which the user focuses attention on the job (attention degree). Further, when a plurality of jobs are executed, priorities of the jobs that define correlations among the plurality of jobs are not taken into consideration, and hence it is not possible to finely control the priorities of the jobs.

On the other hand, according to Patent Literature 2 and Patent Literature 3, the priorities of a plurality of jobs can be dynamically changed, but are determined in consideration of computer resources to be used, time limits for executing the jobs, or the like, and hence it is not possible to schedule the jobs based on the attention degrees to which the user focuses attention on the jobs.

This invention has been made in view of such problems, and therefore an object of this invention is to provide a system for automatically acquiring an attention degree to which a user focuses attention on a job and accurately scheduling the job based on the acquired attention degree.

A representative embodiment of this invention is a computer system including at least one terminal to be used by at least one user, a server coupled to each of the at least one terminal, and a monitoring apparatus for measuring a status of each of the at least one user. The monitoring apparatus is configured to measure first information indicating whether or not the at least one user is present in front of the at least one terminal. The monitoring apparatus is configured to transmit a measurement result including the first information to the server. The at least one terminal is configured to request the server to start a job as instructed by the at least one user and request a progress of the job inquired by the at least one user from the server. The server is configured to retain second information comprising the job requested to be started, the at least one user who has requested the job to be started, a count of requests for the progress of the job, and the at least one user who has requested the progress of the job. The server is configured to calculate an attention degree of the at least one user for the job based on the transmitted measurement result and the second information. The server is configured to determine a priority of the job requested to be started based on the calculated attention degree.

According to one embodiment of this invention, it is possible to determine the priority of the job based on the attention degree to which the user focuses attention on the job.

### BRIEF DESCRIPTION OF THE DRAWINGS

In the accompanying drawings:

FIG. 1 is a block diagram illustrating a configuration of a computer system according to a first embodiment of this invention;

FIG. 2 is a block diagram illustrating a physical configuration of an information processing apparatus according to the first embodiment of this invention;

FIG. 3 is a flowchart illustrating processing for collecting user status information according to the first embodiment of this invention;

FIG. 4 is an explanatory diagram showing a user status table according to the first, embodiment of this invention;

FIG. 5 is a flowchart illustrating processing for receiving an execution request for a job by a server according to the first embodiment of this invention;

FIG. 6 is an explanatory diagram showing an executable job table according to the first embodiment of this invention;

FIG. 7 is an explanatory diagram showing an in-execution job table according to the first embodiment of this invention;

FIG. 8 is an explanatory diagram showing a progress request count table according to the first embodiment of this invention;

FIG. 9 is a flowchart illustrating processing for updating a priority according to the first embodiment of this invention;

FIG. 10 is a flowchart illustrating processing for executing the job with a defined priority according to the first embodiment of this invention; and

FIG. 11 is a block diagram illustrating a configuration of a computer system according to a second embodiment of this invention.

### DETAILED DESCRIPTION OF THE EMBODIMENTS

A computer system according to embodiments of this invention acquirers a degree to which a user requesting execution of a job focuses attention on the job (attention degree), and determines a priority of the job based on the acquired attention degree.

### First Embodiment

Now, a description is made of a first embodiment of this invention for carrying out this invention.

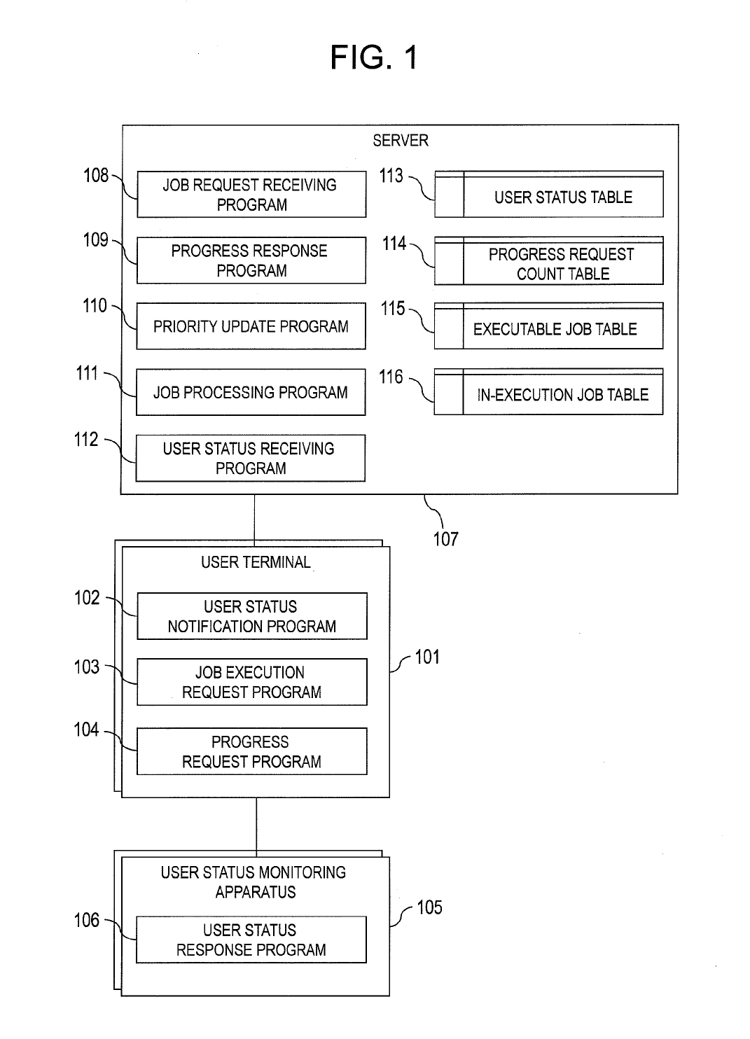

FIG. 1 is a block diagram illustrating a configuration of a computer system according, to the first embodiment of this invention.

The computer system according to the first embodiment of this invention includes a plurality of information processing apparatus coupled to a network. The information processing apparatus according to this embodiment is a computer. The plurality of information processing apparatus include at least one user terminal 101, a server 107, and at least one user status monitoring apparatus 105.

The user terminal 101 is a client of the server 107. The server 107 is an apparatus for receiving a request for the job from the user terminal 101 and processing the job. The user status monitoring apparatus 105 is an apparatus for monitoring a status of the user who uses the user terminal 101. The user terminal 101 and the server 107 are each a computer including an operating system (hereinafter referred to as “OS”).

The user terminal 101 communicates to/from at least one user status monitoring apparatus 105. The server 107 communicates to/from a plurality of user terminals 101.

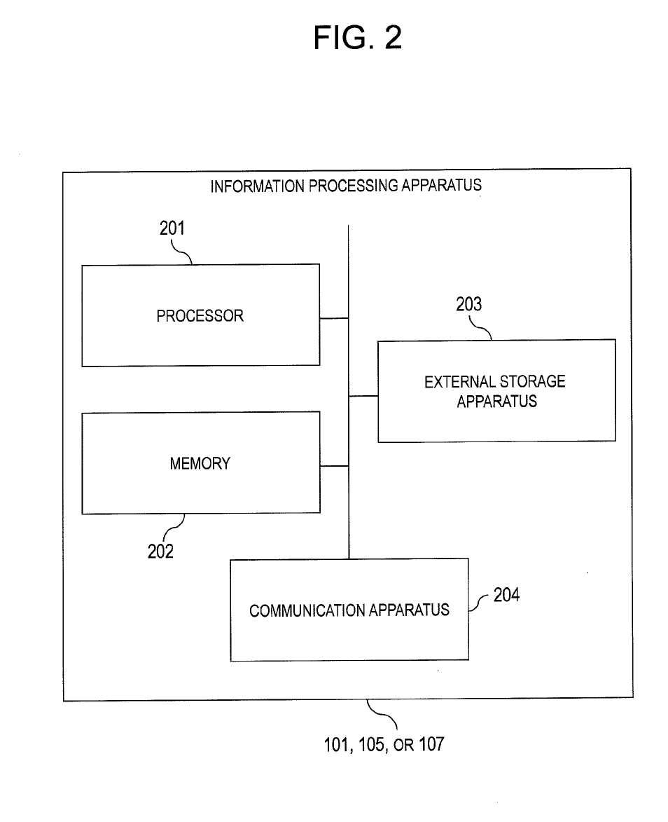

FIG. 2 is a block diagram illustrating a physical configuration of the information processing apparatus according to the first embodiment of this invention.

The server 107 and the user terminal 101 are each an information processing apparatus including a memory 202, a processor 201, an external storage apparatus 203, and a communication apparatus 204. Further, the user status monitoring apparatus 105 is an information processing apparatus including at least the memory 202, the processor 201, and the communication apparatus 204.

The processor 201 is an arithmetic operation apparatus such as a CPU, and may include a plurality of processors. The memory 202 is a primary storage area. The processor 201 reads a program into the memory 202, and executes the read program, to thereby implement each function of each information processing apparatus, which is described later.

The communication apparatus 204 is a network interface such as an NIC, and may include an antenna for radio communications. The respective information processing apparatus communicate to/from one another via the communication apparatus 204 included therein.

An operator or the like stores the program and the like in the external storage apparatus 203 of each server 107, the user terminal 101, and the user status monitoring apparatus 105. When the processor 201 executes the program stored in the external storage apparatus 203 by the OS included in each information processing apparatus, the program stored in the external storage apparatus 203 is read into the memory 202. Therefore, it is assumed that a group of programs described later are stored in the memory 202 of the each information processing apparatus.

The user status monitoring apparatus 105 includes, for example, an apparatus for measuring the status of the user such as a camera, a human sensor, or a seated state sensor. With this configuration, the user status monitoring apparatus 105 can acquire information necessary to determine whether or not the user is present in front of a display of the user terminal 101. It should be noted that the camera included in the user status monitoring apparatus 105 is, for example, a Web camera.

Further, specifically, when the user status monitoring apparatus 105 includes the camera, the user status monitoring apparatus 105 can photograph the user's facial expressions. Further, when the user status monitoring apparatus 105 includes the human sensor for sensing a temperature or a frequency, the user status monitoring apparatus 105 can measure the users temperature, the user's body movement, or the like. Further, when the user status monitoring apparatus 105 includes the seated state sensor, the user status monitoring apparatus 105 can measure whether or not the user is present.

It should be noted that when the user status monitoring apparatus 105 includes the human sensor that can measure the user's body movement, the user status monitoring apparatus 105 includes the camera, the seated state sensor, or the like along with the human sensor in order to acquire whether or not the user is present. Further, the user status monitoring apparatus 105 may include a plurality of sensors for measuring the status of the user.

The server 107 includes a job request receiving program 108, a progress response program 109, a priority update program 110, a job processing program 111, a user status receiving program 112, a user status table 113, a progress request count table 114, an executable job table 115, and an in-execution job table 116.

The job request receiving program 108 has a function for receiving an execution request for the job transmitted from the user terminal 101. The progress response program 109 has a function for transmitting a progress of the job to the user terminal 101. The priority update program 110 has a function for changing the priority of the job.

The job processing program 111 has a function for processing the job. The user status receiving program 112 has a function for receiving information indicating the status of the user (hereinafter referred to as “user status information”) transmitted from the user status monitoring apparatus 105.

The user status table 113 is a table for storing the user status information. The progress request count table 114 is a table for storing a count of requests for the progress of the job made by the user terminal 101.

The executable job table 115 is a table for storing information indicating whether or not the job requested by the user terminal 101 can be executed. The in-execution job table 116 is a table for storing information indicating the job in execution.

The user terminal 101 includes a user status notification program 102, a job execution request program 103, and a progress request program 104. The user status notification program 102 has a function for transmitting the user status information transmitted from the user status monitoring apparatus 105 to the server 107.

The job execution request program 103 has a function for requesting execution of the job. The progress request program 104 has a function for requesting the server 107 to transmit the progress of the job.

The user status monitoring apparatus 105 includes a user status response program 106. The user status response program 106 has a function for transmitting the user status information to the server 107 in response to the request for the user status information made by the server 107. When the user status monitoring apparatus 105 includes the camera, the user status information is an image obtained by the photographing through the camera. When the user status monitoring apparatus 105 includes the human sensor, the user status information is a value of the frequency indicating the body movement, the temperature, or the like that is measured through the human sensor. Further, when the user status monitoring apparatus 105 includes the seated state sensor, the user status information is an identifier indicating whether the user is present or absent.

It should be noted that the processor 201 operates as a functional part for realizing a predetermined function by processing the above-mentioned program. For example, the processor 201 functions as a job request receiving part by processing the job request receiving program 108, and functions as a progress response part by processing the progress response program 109. The same applies to the other programs. In addition, the processor 201 also operates as a functional part for realizing each of a plurality of processes executed by each program. The information processing apparatus according to this embodiment is an apparatus or a system including those functional parts.

Further, the program according to this embodiment may be installed to each information, processing apparatus through a program distribution server or a non-transitory storage medium that is readable by the information processing apparatus, and be stored in a nonvolatile memory device (external storage apparatus 203) of each information processing apparatus.

Further, the program for implementing each function and the information stored in the table or the like may be stored in a memory device such as a nonvolatile semiconductor memory, a hard disk drive, or a solid-state drive (SSD), or a computer-readable non-transitory data storage medium such as an IC card, an SD card, or a DVD.

Further, the server 107, the user terminal 101, and the user status monitoring apparatus 105 described above are each implemented by one computer, but the information processing apparatus according to this embodiment may be implemented by a plurality of information processing apparatus including a plurality of processors 201. Alternatively, all of the server 107, the user terminal 101, and the user status monitoring apparatus 105 may be implemented by one casing. Further, the processor 201, the memory 202, the external storage apparatus 203, and the communication apparatus 204 may be a processor, a memory, an external storage apparatus, and a communication apparatus that are virtualized by a plurality of processors, memories, external storage apparatus, and communication apparatus, respectively.

Now, a description is made of processing of the computer system according to this embodiment.

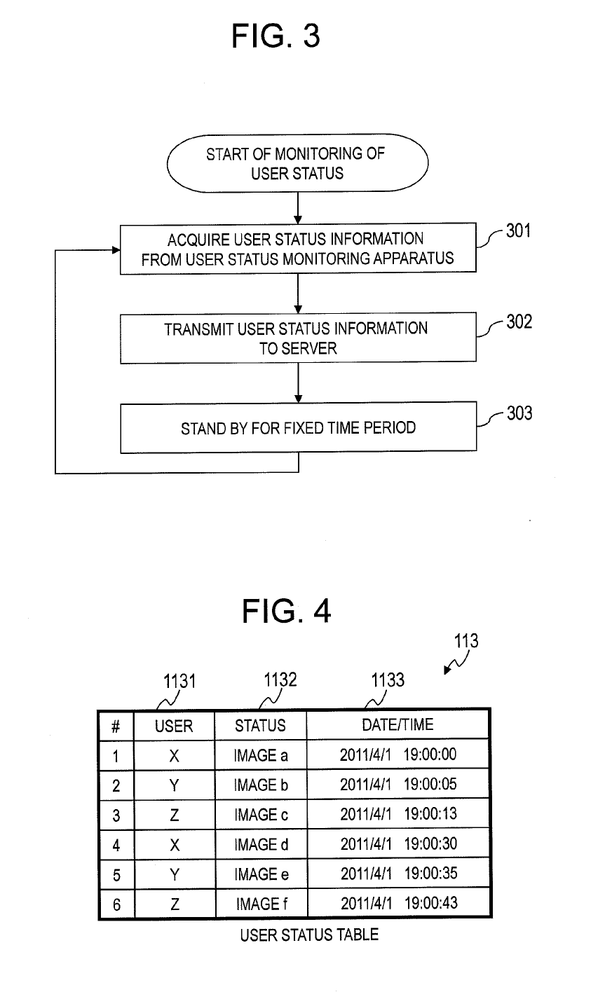

FIG. 3 is a flowchart illustrating processing for collecting the user status information according to the first embodiment of this invention.

The OS included in the user terminal 101 activates the user status notification program 102. When being activated by the OS included in the user terminal 101, the user status notification program 102 requests the user status information from the user status response program 106, to thereby acquire the user status information from the user status monitoring apparatus 105 (Step 301).

The user status response program 106 uses an apparatus such as the camera included therein to measure the user, to thereby periodically acquire the user status information. When receiving the request for the user status information by the user status notification program 102, the user status response program 106 transmits the acquired user status information and a date/time at which the user status information is acquired to the user status notification program 102 of the user terminal 101.

When receiving the user status information from the user status response program 106, the user status notification program 102 acquires an identifier of the user corresponding to the user status information. The identifier of the user is an identifier for uniquely indicating the user, and each of the programs included in the server 107 and the user terminal 101 uses the identifier of the user to identify each user.

When one user uses one user terminal 101, the user status notification program 102 may acquire an identifier of the one user terminal 101 as the identifier of the user. Further, when a plurality of users use one user terminal 101, the user status notification program 102 may acquire an identifier input in a user authentication performed by the user to use the user terminal 101, as the identifier of the user corresponding to the user status information.

It should be noted that the user status monitoring apparatus 105 may retain the identifier of the user in advance by having the identifier transmitted from the user terminal 101. In a case where the user status monitoring apparatus 105 retains the identifier of the user in advance, the user status response program 106 may transmit the user status information including the identifier of the user to the user terminal 101.

Then, the user status notification program 102 includes the identifier of the user and the date/time at which the user status information is acquired in the acquired user status information. Then, the user status notification program 102 transmits the user status information including the identifier of the user to the server 107 (Step 302). Then, the user status receiving program 112 of the server 107 receives the user status information and the like from the user terminal 101. The user status receiving program 112 stores the received user status information and the like into the user status table 113.

Then, in order to cause the user status monitoring apparatus 105 to measure the user status information sufficiently, the user status notification program 102 stands by for a predetermined time period after transmitting the user status information to the server 107 (Step 303), and then returns to Step 301.

FIG. 4 is an explanatory diagram showing the user status table 113 according to the first embodiment of this invention.

The user status table 113 includes a user 1131, a status 1132, and a date/time 1133. The user 1131 includes the identifier of the user corresponding to the user status information. The status 1132 includes the user status information on the user who uses the user terminal 101. The date/time 1133 includes the date/time at which the user status information included in the status 1132 is acquired.

When the user status monitoring apparatus 105 includes the camera, the user status information included in the status 1132 is an identifier of an image or the image. The identifier of the image is a folder name of a folder storing the image, a file name thereof, or the like. Each of the programs stored in the server 107 identifies the status 1132, to thereby identify the image included in the user status information.

Further, when the user status monitoring apparatus 105 includes the human sensor for measuring the temperature or the frequency, the user status information included in the status 1132 is the value indicating the user's temperature or the frequency indicating the user's body movement Further, when the user status monitoring apparatus 105 includes the seated state sensor, the user status information included in the status 1132 is the identifier indicating whether the user is present or absent.

It should be noted that when the user status monitoring apparatus 105 includes a plurality of the apparatus (camera and the like) described above for measuring the status of the user, the status 1132 may include a plurality of pieces of user status information acquired from the respective apparatus.

The user status table 113 shown in FIG. 4 has two rows corresponding to each user, but the user status table 113 according to this embodiment may include a plurality of rows acquired in a fixed time period, in other words, a plurality of pieces of user status information. Further, in a case where only the most recent piece of user status information is used for processing described later, the user status table 113 according to this embodiment may retain only a row including only the most recent piece of user status information.

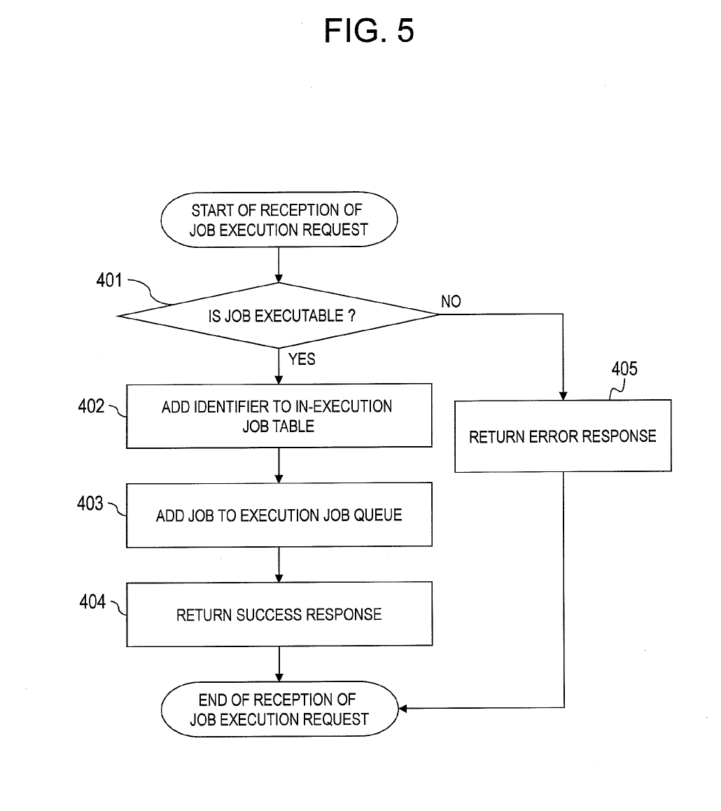

FIG. 5 is a flowchart illustrating processing for receiving the execution request for the job by the server 107 according to the first embodiment of this invention.

When the user requests the execution of the job from the server 107, each of the programs stored in the server 107 executes processing illustrated in FIG. 5.

in order to request the execution of the job, the user activates the job execution request program 103 of the user terminal 101. When being activated by the user, the job execution request program 103 acquires information relating to the job whose execution has been requested by the user, and transmits the execution request for the job, which includes the acquired information relating to the job and the identifier for uniquely indicating the user requesting the execution of the job, to the server 107.

The information relating to the job represents an identifier of the job or the like. Each of the programs stored in the server 107 and the user terminal 101 uses the identifier of the job to uniquely identify the job.

The job request receiving program 108 of the server 107 receives the execution request for the job transmitted from the job execution request program 103. The job request receiving program 108 according to the first embodiment is a program for providing a service for receiving an HTTP request. However, the job request receiving program 108 according to this embodiment may be a program for providing any service that receives requests for the execution of the job and returns an execution result of the job.

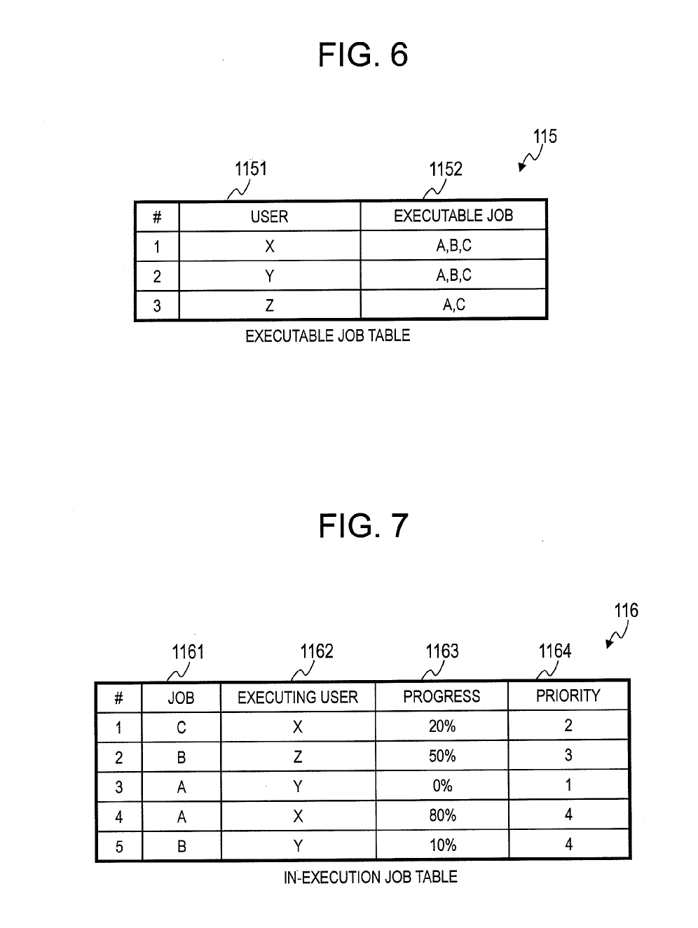

The job request receiving program 108 refers to the executable job table 115 shown in FIG. 6 to determine whether or not the user requesting the execution of the job can execute the requested job (Step 401).

FIG. 6 is an explanatory diagram showing the executable job table 115 according to the first embodiment of this invention.

The executable job table 115 includes a user 1151 and an executable job 1152. The user 1151 includes the identifier of the user that can execute the job. The user 1151 and the user 1131 include corresponding values. The executable job 1152 includes the identifier of the job executable by the user indicated by the user 1151.

In Step 401, the job request receiving program 108 identifies a row of the executable job table 115 by the identifier of the user included in the execution request for the job transmitted from the job execution request program 103, and identifies the executable job 1152 included in the identified row. When the identified executable job 1152 includes the identifier of the job included in the transmitted execution request for the job, the job request receiving program 108 determines the user requesting the execution of the job can execute the requested job.

When the user requesting the execution of the job cannot execute the requested job, the job cannot be executed, and hence the job request receiving program 108 transmits an error response to the user terminal 101 (Step 405). Then, the processing illustrated in FIG. 5 is brought to an end.

When the user requesting the execution of the job can execute the requested job, the job request receiving program 108 adds the identifier indicating the job to the in-execution job table 116 (Step 402).

FIG. 7 is an explanatory diagram showing the in-execution job table 116 according to the first embodiment of this invention.

The in-execution job table 116 includes a job 1161, an executing user 1162, a progress 1163, and a priority 1164. The job 1161 includes the identifier indicating the job in execution. The executing user 1162 includes the identifier of the user that has requested the execution of the job. The progress 1163 includes a progress indicating how far the job in execution has been executed. The priority 1164 includes the priority of the job to be started or the priority of the job in execution.

The executing user 1162 includes the value corresponding to the user 1151 of the executable job table 115. The job 1161 includes the value corresponding to the executable job 1152 of the executable job table 115.

In Step 402, the job request receiving program 108 stores the identifier of the user included in the transmitted execution request for the job into the executing user 1162, and stores the identifier indicating the job included in the transmitted execution request for the job into the job 1161.

Then, the job request receiving program 108 adds the job whose execution has been requested by the user to an execution job queue (Step 403). The execution job queue is a queue retained in the memory 202 of the server 107, and retains the job whose execution is scheduled.

After Step 403, the job request receiving program 108 transmits a success response to the user terminal 101 (Step 404). Then, the processing illustrated in FIG. 5 is brought to an end.

For example, when a user X (user whose identifier is “X”; the same shall apply hereinafter) requests the execution of the job C (job whose identifier is “C”; the same shall apply hereinafter), the job request receiving program 108 refers to the executable job table 115 shown in FIG. 6 to determine that the user X can execute the job C (Step 401).

Then, in Step 402, the job request receiving program 108 adds a row including “C” in the job 1161 of the in-execution job table 116 and “X” in the executing user 1162. Then, in Step 403, the job request receiving program 108 adds the job C to the execution job queue. After transmitting the success response to the user terminal 101, the processing is brought to an end.

Further, for example, when a user Z (user whose identifier is “Z”; the same shall apply hereinafter) requests the execution of the job C, the job request receiving program 108 refers to the executable job table 115 shown in FIG. 6 to determine that the user Z cannot execute the job C (Step 401). Therefore, after transmitting the error response to the user terminal 101 in Step 405, the processing is brought to an end.

It should be noted that when there is no need to manage executable jobs on a user-to-user basis, the executable job table 115 may include only one field of the executable job 1152, or the in-execution job table 116 may exclude the executing user 1162. Further, the job request receiving program 108 may determine in Step 401 only whether or not the job can be executed.

By the processing illustrated in FIG. 5, the job whose execution has been requested by the user is added to the execution job queue and stored into the in-execution job table 116 that indicates that the job is in execution.

After the processing illustrated in FIG. 5, in order to inquire how far the job has been executed, the user inquires the progress of the job from the server 107 through the user terminal 101. In general, when the user focuses most attention on the job, the user frequently inquirers the progress.

In order to inquire the progress of the job, the user activates the progress request program 104 of the user terminal 101. When being activated by the user, the progress request program 104 inquires the progress of the job from the server 107. The progress request program 104 requests the progress of the job from the server 107 by transmitting a request for the progress including the identifier of the job whose progress has been requested by the user.

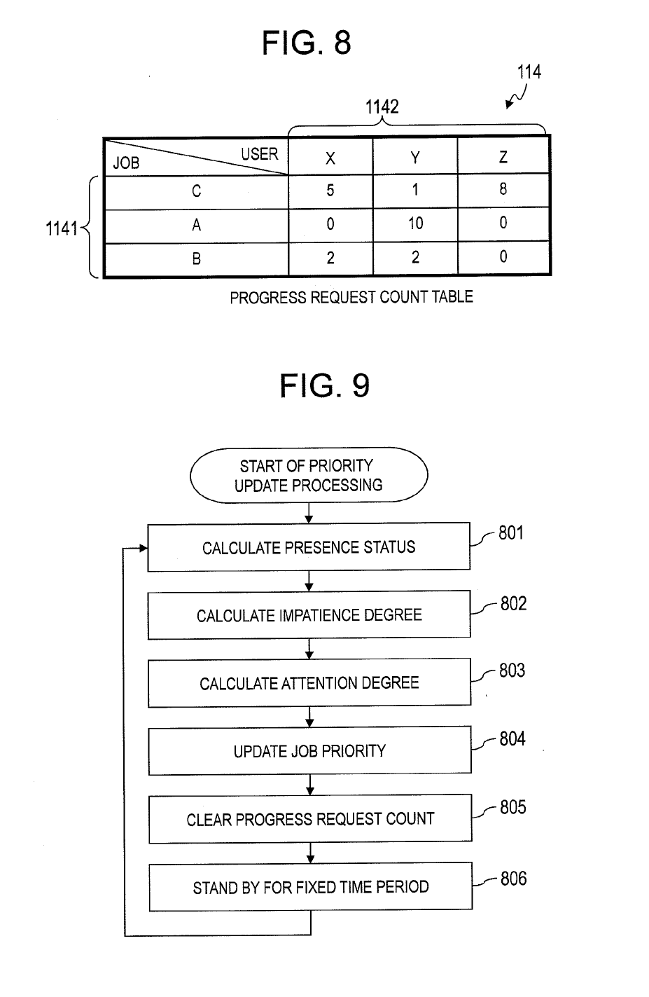

When receiving the request for the progress from the progress request program 104, the progress response program 109 of the server 107 refers to the progress 1163 of the in-execution job table 116 to transmit the requested progress of the job to the user terminal 101. Then, the progress response program 109 increases a value of a cell indicated by a row 1141 including the identifier of the job whose progress has been requested and a column 1142 including the identifier of the user who has requested the progress of the progress request count table 114 shown in FIG. 8.

FIG. 8 is an explanatory diagram showing the progress request count table 114 according to the first embodiment of this invention.

A progress request count stored in the progress request count table 114 is used for determination of the priority described later. In the progress request count table 114, each row 1141 indicates each job, and each column 1142 indicates each user.

The row 1141 includes a value corresponding to the executable job 1152 of the executable job table 115 and the job 1161 of the in-execution job table 116. The column 1142 includes a value corresponding to the user 1131 of the user status table 113, the user 1151 of the executable job table 115, and the executing user 1162 of the in-execution job table 116.

For example, when the job whose progress has been requested is the job whose execution has been requested by the user who has requested the progress, the progress response program 109 increases the value of the cell by 2. Further, when the job whose progress has been requested is the job whose execution has been requested by a user other than the user who has requested the progress, the progress response program 109 increases the value of the cell by 1.

Specifically, the progress response program 109 refers to the in-execution job table 116 to identify which user has requested the execution of the job whose progress has been requested. Then, the progress response program 109 determines whether or not the identified user is the user who has requested the progress. When the identified user is the user who has requested the progress, the request for the progress made by the user is an inquiry having high necessity, which indicates that the user focuses most attention on the job.

Therefore, the progress response program 109 adds 2 to the value of the cell corresponding to the job whose progress has been requested and the user who has requested the progress within the progress request count table 114.

Further, when the identified user is not the user who has requested the progress, it is indicated that the request for the progress is a request having necessity to a normal degree. Therefore, the progress response program 109 adds 1 to the value of the cell corresponding to the job whose progress has been requested and the user who has requested the progress within the progress request count table 114.

For example, in a case where the progress request count table 114 includes values shown in FIG. 8 and the in-execution job table 116 includes values shown in FIG. 7, when the user X requests the progress of the job B (job whose identifier is “B”; the same shall apply hereinafter), the progress response program 109 refers to the in-execution job table 116 to acquire that the user X has not requested the execution of the job B. Then, the progress response program 109 adds 1 to the value of the cell corresponding to the user X and the job B within the progress request count table 114.

On the other hand, when the user X requests the progress of the job C, the progress response program 109 refers to the in-execution job table 116 to acquire that the user X has requested the execution of the job C. Then, the progress response program 109 adds 2 to the value of the cell corresponding to the user X and the job C within the progress request count table 114.

The progress response program 109 changes the value stored in the progress request count table 114 in accordance with the count of requests for the progress and the user who has requested the progress, by which the progress request count table 114 can indicate a degree of attention focused on the job by the user by using a numerical value. Further, in processing described later, the priorities are determined based on the value stored in the progress request count table 114.

It should be noted that the progress response program 109 may change an amount, by which the value of the cell within the progress request count table 114 is increased, to an arbitrary value. For example, a weight of the inquiry about the progress may be defined for each user who has requested the execution, to thereby change the value to be added.

FIG. 9 is a flowchart illustrating processing for updating the priority according to the first embodiment of this invention.

The processing illustrated in FIG. 9 is periodically executed before a start of the job and during the execution of the job. By the processing illustrated in FIG. 9, the priority of the job to be started or the priority of the job in execution is determined.

The priority update program 110 of the server 107 periodically executes the processing illustrated in FIG. 9. First, the priority update program 110 refers to the status 1132 of the user status table 113 to acquire the user status information. Then, the priority update program 110 determines a presence status of the user (Step 801). In Step 801, the priority update program 110 assigns 1 to the presence status of the user when the user is present, and assigns 0 to the presence status of the user when the user is absent.

For example, when the user status monitoring apparatus 105 includes the camera, the image is included in the acquired user status information. The priority update program 110 analyzes the image included in the user status information, and determines whether or not the user (in other words, human) is in front of the user terminal 101, to thereby determine whether or not the user is present.

Further, when the user status monitoring apparatus 105 includes the human sensor for measuring the temperature, the priority update program 110 determines whether or not an atmosphere in front of the user terminal 101 has approximately the same temperature as a human temperature, to thereby determine whether or not the user is present.

Further, when the user status monitoring apparatus 105 includes the seated state sensor for measuring the temperature, the priority update program 110 determines whether the identifier included in the status 1132 indicates presence or absence, to thereby determine whether or not the user is present.

After Step 801, the priority update program 110 analyzes the user status information, and calculates an impatience degree of the user (Step 802). The impatience degree according to this embodiment is evaluated by three statuses including “in good mood”, “normal”, and “in bad mood”, to which numerical values 1, 2, and 3 are assigned, respectively. Those numerical values may be changed based on which status indicates that the user focuses most attention on the job.

In other words, the impatience degree according to this embodiment has a value indicating how impatient the user is while waiting for the completion of the job. When the user is “in bad mood”, the attention degree to which the user focuses attention on whether or not the job is being executed is highest. Therefore, when the user is “in bad mood”, the highest value is assigned to the impatience degree according to this embodiment. Further, when the user is “in good mood”, the attention degree to which the user focuses attention on whether or not the job is being executed is lowest. Therefore, when the user is “in good mood”, the lowest value is assigned to the impatience degree according to this embodiment.

For example, when the user status monitoring apparatus 105 includes the camera, the priority update program 110 analyzes the user's facial expressions displayed in the image indicating the user status information. Then, the priority update program 110 calculates a degree to which wrinkles are formed between the user's eyebrows. When the degree to which the wrinkles are formed is high, the priority update program 110 may determine that the user is “in bad mood” and assign 3 to the impatience degree. Alternatively, when the degree to which the wrinkles are formed is low, the priority update program 110 may determine that the user is “normal” or “in good mood” and assign 2 or 1 to the impatience degree, respectively.

Further, when the user status monitoring apparatus 105 includes the camera, the priority update program 110 calculates a degree to which corners of a mouth on the user's face are raised. When the calculated degree indicates that the corners of the mouth are raised, the priority update program 110 may determine that the user is “in good mood” and assign 1 to the impatience degree. Alternatively, when the calculated degree indicates that the corners of the mouth are lowered, the priority update program 110 may determine that the user is “in bad mood” and assign 3 to the impatience degree. Further, when the corners of the mouth coincide with tip ends of the parallel lips, the priority update program 110 may determine that the user is “normal” and assign 2 to the impatience degree.

Examples of a technology for recognizing the user's facial expressions from the image include a smiling face recognition technology included in a digital camera or the like. In general, the smiling face recognition technology included in a digital camera or the like identifies an emotion of a photographed person based on a layout of eyes, a mouth, an outline, and the like of the photographed person.

Further, for example, when the user status monitoring apparatus 105 includes the human sensor for measuring the temperature, the priority update program 110 identifies the user's temperature during a fixed time period from the user status information. If the user's temperature has risen for the fixed time period, the priority update program 110 may determine that the user is “in bad mood” and may assign 3 to the impatience degree. Alternatively, if there is no change in the user's temperature during the fixed time period, the priority update program 110 may determine that the user is “normal” or “in good mood” and may assign 2 or 1 to the impatience degree, respectively.

Further, for example, when the user status monitoring apparatus 105 includes the human sensor for measuring the body movement, the priority update program 110 identifies the user's body movement during a fixed time period from the user status information. If the frequency of the user's body movement has risen for the fixed time period or has a value higher than a predetermined threshold value, it is highly possible that the user is acting nervously such as jiggling his/her legs, and hence the priority update program 110 may determine that the user is “in bad mood” and may assign 3 to the impatience degree. Alternatively, if the frequency of the user's body movement has decreased for the fixed time period or has a value lower than the predetermined threshold value, the priority update program 110 may determine that the user is “normal” or “in good mood” and may assign 2 or 1 to the impatience degree, respectively.

The priority update program 110 defines the impatience degree by using a numerical value based on the statuses determined by the plurality of methods described above. Here, a comprehensive impatience degree may be calculated by multiplying the impatience degree by a pre-defined weighting factor and adding up results of the multiplication.

After Step 802, the priority update program 110 calculates the attention degree to which the user focuses attention on the job based on the presence status determined in Step 801, the progress request count shown in the progress request count table 114, and the impatience degree calculated in Step 802 (Step 803). The attention degree to which the user X focuses attention on the job A (job whose identifier is “A”; the same shall apply hereinafter) is calculated by Expression (1).

(attention degree to which the user X focuses attention on the job A)=(progress request count of the user X for the job A)×(presence status of the user X)×(impatience degree of the user X) (1)

In addition, the attention degree for the job A is calculated as follows.

(attention degree for the job A)=(total sum of the attention degrees of all the users for the job A) (2)

According to Expression (2), the attention degree according to this embodiment is calculated based on the respective factors of the progress request count, the presence status, and the impatience degree. An administrator or the like may assign weights to the respective factors of the progress request count, the presence status, and the impatience degree based on the importance of the progress request count, the presence status, and the impatience degree.

The presence status according to the first embodiment is 0 or 1 as described above, and hence the attention degree in the case where the user is not present is constantly 0. Further, when the server 107 does not have a function such as a face recognition function for acquiring the information necessary to calculate the impatience degree, the priority update program 110 cannot calculate the impatience degree, and hence the impatience degree may be constantly defined as 1. Further, if the user wishes to execute the job to some extent even when the user is not present, the attention degree in the case where the user is not present may be defined as a small value such as 0.1.

Further, in order to raise the priority of the job on the progress of which the attention is focused by a large number of users, in Step 803, the priority update program 110 may change the value of the progress request count depending on the number of users who have requested the progress. Then, the priority update program 110 may calculate the attention degree based on the changed value of the progress request count.

For example, when the job C has the progress requested by the user X, a user Y (user whose identifier is “Y”; the same shall apply hereinafter) and a user 1, the priority update program 110 may multiply by 3 the respective values stored in the row including the job C within the progress request count table 114. Then, the priority update program 110 may calculate Expression (1) and Expression (2) described above by using results of multiplying the progress request counts by 3.

After Step 803, the priority update program 110 updates the priority of the job based on the attention degree calculated in Step 803 (Step 804). For example, to define the priorities in a plurality of steps between a lower limit value and an upper limit value, the priority update program 110 may proportionally distribute the priorities between the lower limit value and the upper limit value of the priorities in accordance with the values of the attention degrees of the respective jobs.

Specifically, in a case where the priority ranges from 1 to 12 with the attention degree for the job A being 16, the attention degree for the job B being 8, and the attention degree for the job C being 24, the priority update program 110 sets the priority of the job A to 4, the priority of the job B to 2, and the priority of the job C to 6. It should be noted that the priority according to this embodiment indicates that the job having a higher value thereof is more preferentially executed.

Further, the priority update program 110 may lower the priority when the attention degree is equal to or smaller than a given threshold value, and may raise the priority when the attention degree is larger than the threshold value. Further, for example, when the OS included in the server 107 is Linux, the priority may be assigned to a process in execution by using 40 steps ranging from −19 (minus nineteen) to 20 according to a renice command.

In Step 804, the priority update program 110 defines the priority based on the attention degree, and stores the defined priority into the priority 1164 of the in-execution job table 116.

After Step 804, the priority update program 110 updates all the progress request counts stored in the progress request count table 114 to zero (0) (Step 805). This update is performed in order to calculate the attention degree of the user based on the most recent situation of the requests for the progress.

After Step 805, the priority update program 110 stands by for a predetermined time period for acquiring the sufficient situation of the requests for the progress (Step 806), and then returns to Step 801.

In the above-mentioned processing illustrated in FIG. 9, the priority update program 110 calculates the attention degree by using all of the presence status of the user, the impatience degree of the user, and the progress request count. However, the priority update program 110 according to this embodiment may calculate the attention degree by using one or two elements of the presence status of the user, the impatience degree of the user, and the progress request count. For example, the priority update program 110 may calculate the attention degree by using the presence status of the user and the progress request count.

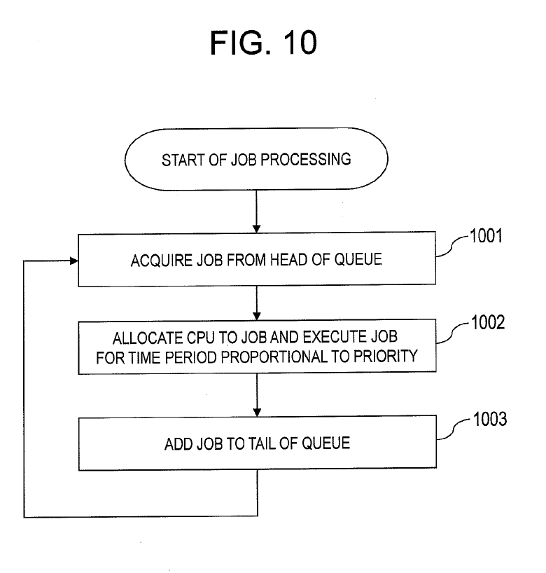

FIG. 10 is a flowchart illustrating processing for executing the job with a defined priority according to the first embodiment of this invention.

The processing illustrated in FIG. 10 is executed after the processing illustrated in FIG. 9 is executed. The processing illustrated in FIG. 10 is executed before the start of each job or during the execution of each job.

The job processing program 111 refers to the execution job queue retained in the memory 202 of the server 107 to acquire the job from a head of the execution job queue (Step 1001). After Step 1001, the job processing program 111 refers to the priority 1164 of the in-execution job table 116 to allocate the processor 201 to each job and execute the job for a time period proportional to the value stored in the priority 1164 (Step 1002).

After Step 1002, the job processing program 111 adds the job whose execution is unfinished among the jobs each of which has been executed for the time period allocated in Step 1002 to a tail of the execution job queue (Step 1003). Subsequently, the job processing pr gram 111 returns to Step 1001 to acquire a new job from the head of the execution job queue.

It should be noted that in Step 1003, the job processing program 111 acquires the progress of the job, and stores the progress into the progress 1163 of the in-execution job table 116.

According to the first embodiment, the priority of the job can be finely controlled based on the attention degrees of a plurality of users for the job in a client-server system used by the plurality of users. Accordingly, it is possible to effectively make use of computer resources while improving a level of satisfaction of each user.

### Second Embodiment

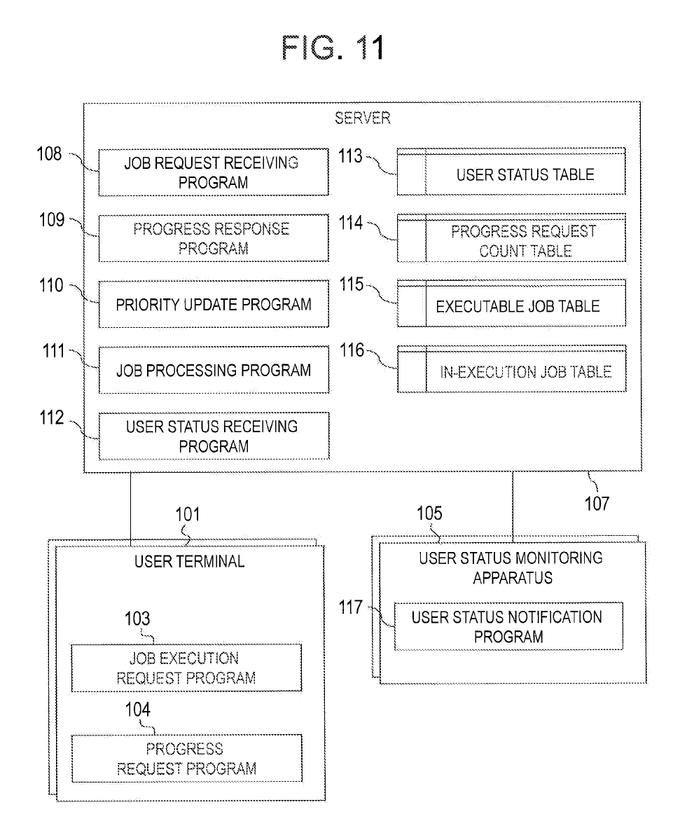

FIG. 11 is a block diagram illustrating a configuration of a computer system according to a second embodiment of this invention.

The computer system according to the second embodiment is different from the computer system according to the first embodiment in that the user status monitoring apparatus 105 is directly coupled to the server 107 and that the user status monitoring apparatus 105 includes a user status notification program 117. Therefore, the user terminal 101 does not need to include the user status notification program 102. The programs and the tables that are common to the computer system according to the first embodiment and the computer system according to the second embodiment have the same functions and the same values.

In the second embodiment, the identifier indicating the user who uses the user terminal 101 is previously retained in the user status monitoring apparatus 105. The user status notification program 117 acquires the user status information by using the camera or the like included in the user status monitoring apparatus 105, and periodically transmits the previously-given identifier of the user and the user status information to the server 107.

Then, the user status receiving program 112 of the server 107 receives the user status information transmitted from the user status monitoring apparatus 105, and executes the processing illustrated in FIG. 3.

According to the second embodiment, the user terminal 101 does not include the user status notification program 102, and therefore it is possible to reduce load imposed on the user terminal 101.

Though the detailed description has been given of this invention referring to the attached drawings, this invention is not limited to those specific configurations, and includes various variations and equivalent configurations within the scope of the accompanying claims.

The computer systems according to those embodiments are each a client-server system including a plurality of clients, and can be applied to a system in which a user uses a client to request a server to execute a job.

1. A computer system, comprising:
at least one terminal to be used by at least one user;
a server coupled to each of the at least one terminal; and
a monitoring apparatus for measuring a status of each of the at least one user,
wherein the monitoring apparatus is configured to:
measure first information indicating whether or not the at least one user is present in front of the at least one terminal; and
transmit a measurement result including the first information to the server,
wherein the at least one terminal is configured to:
request the server to start a job as instructed by the at least one user; and
request a progress of the job inquired by the at least one user from the server, and
wherein the server is configured to:
retain second information comprising the job requested to be started, the at least one user who has requested the job to be started, a count of requests for the progress of the job, and the at least one user who has requested the progress of the job;
calculate an attention degree of the at least one user for the job based on the transmitted measurement result and the second information;
determine a priority of the job requested to be started based on the calculated attention degree;
update, when the priority is determined, the count of requests for the progress of the job included in the second information to zero;
add, in a case where a first job instructed to be started by a first user has been requested to be started, when the progress of the first job inquired by a second user is requested, a first value to the count of requests for the progress of the first job included in the second information; and
add, in a case where the first job instructed to be started by the first user has been requested to be started, when the progress of the first job inquired by the first user is requested, a value higher than the first value to the count of requests for the progress of the first job included in the second information.

2. The computer system according to claim 1,
wherein the monitoring apparatus is further configured to include third information indicating the measured status of the at least one user in the measurement result, and
wherein the server is further configured to:
determine a degree of impatience of the at least one user based on the third information included in the transmitted measurement result; and
calculate the attention degree of the at least one user based on a result of the determination, the first information, and the second information.

3. The computer system according to claim 2,
wherein the monitoring apparatus is further configured to acquire an image indicating the status of the at least one user, and
wherein the third information comprises the acquired image indicating the status of the at least one user.

4. The computer system according to claim 2,
wherein the monitoring apparatus is further configured to measure one of a temperature and a body movement of the at least one user, and
wherein the third information indicates the measured one of the temperature and the body movement of the at least one user.

5. (canceled)

6. (canceled)

7. A computer system, comprising:
at least one terminal to be used by at least one user;
a server coupled to each of the at least one terminal; and
a monitoring apparatus for measuring a status of each of the at least one user,
wherein the monitoring apparatus is configured to:
measure first information indicating whether or not the at least one user is present in front of the at least one terminal; and
transmit a measurement result including the first information to the server,
wherein the at least one terminal is configured to:
request the server to start a job as instructed by the at least one user; and
request a progress of the job inquired by the at least one user from the server, and
wherein the server is configured to:
retain second information comprising the job requested to be started, the at least one user who has requested the job to be started, a count of requests for the progress of the job, and the at least one user who has requested the progress of the job;
calculate an attention degree of the at least one user for the job based on the transmitted measurement result and the second information;
determine a priority of the job requested to be started based on the calculated attention degree;
update, when the priority is determined, the count of requests for the progress of the job included in the second information to zero;
add, when a number of users who inquired the progress of a second job is one, a second value to the count of requests for the progress of the second job included in the second information; and
add, when the number of users who inquired the progress of a second job is more than one, a value higher than the second value to the count of requests for the progress of the second job included in the second information.

8. An information processing method for use in a computer system,
the computer system comprising:
at least one terminal to be used by at least one user;
a server coupled to each of the at least one terminal; and
a monitoring apparatus for measuring a status of each of the at least one user,
the information processing method comprising:
measuring, by the monitoring apparatus, first information indicating whether or not the at least one user is present in front of the at least one terminal;
transmitting, by the monitoring apparatus, a measurement result including the first information to the server;
requesting, by the at least one terminal, the server to start a job as instructed by the at least one user;
requesting, by the at least one terminal, from the server a progress of the job inquired by the at least one user;
retaining, by the server, second information comprising the job requested to be started, the at least one user who has requested the job to be started, a count of requests for the progress of the job, and the at least one user who has requested the progress of the job;
calculating, by the server, an attention degree of the at least one user for the job based on the transmitted measurement result and the second information;
determining, by the server, a priority of the job requested to be started based on the calculated attention degree;
updating, by the server, when the priority is determined, the count of requests for the progress of the job included in the second information to zero;
adding, by the server, in a case where a first job instructed to be started by a first user has been requested to be started, when the progress of the first job inquired by a second user is requested, a first value to the count of requests for the progress of the first job included in the second information; and
adding, by the server, in the case where the first job instructed to be started by the first user has been requested to be started, when the progress of the first job inquired by the first user is requested, a value higher than the first value to the count of requests for the progress of the first job included in the second information.

9. The information processing method according to claim 8, further comprising:
including, by the monitoring apparatus, third information indicating the measured status of the at least one user in the measurement result;
determining, by the server, a degree of impatience of the at least one user based on the third information included in the transmitted measurement result; and
calculating, by the server, the attention degree of the at least one user based on a result of the determination, the first information, and the second information.

10. The information processing method according to claim 9, further comprising acquiring, by the monitoring apparatus, an image indicating the status of the at least one user,
wherein the third information comprises the acquired image indicating the status of the at least one user.

11. The information processing method according to claim 9, further comprising measuring, by the monitoring apparatus, one of a temperature and a body movement of the at least one user,
wherein the third information indicates the measured one of the temperature and the body movement of the at least one user.

12. (canceled)

13. (canceled)

14. An information processing method for use in a computer system,
the computer system comprising:
at least one terminal to be used by at least one user;
a server coupled to each of the at least one terminal; and
a monitoring apparatus for measuring a status of each of the at least one user,
the information processing method comprising:
measuring, by the monitoring apparatus, first information indicating whether or not the at least one user is present in front of the at least one terminal;
transmitting, by the monitoring apparatus, a measurement result including the first information to the server;
requesting, by the at least one terminal, the server to start a job as instructed by the at least one user;
requesting, by the at least one terminal, from the server a progress of the job inquired by the at least one user;
retaining, by the server, second information comprising the job requested to be started, the at least one user who has requested the job to be started, a count of requests for the progress of the job, and the at least one user who has requested the progress of the job;
calculating, by the server, an attention degree of the at least one user for the job based on the transmitted measurement result and the second information;
determining, by the server, a priority of the job requested to be started based on the calculated attention degree;
updating, by the server, when the priority is determined, the count of requests for the progress of the job included in the second information to zero;
adding, by the server, when a number of users who inquired the progress of a second job is one, a second value to the count of requests for the progress of the second job included in the second information; and
adding, by the server, when the number of users who inquired the progress of a second job is more than one, a value higher than the second value to the count of requests for the progress of the second job included in the second information.

15. The computer system according to claim 7,
wherein the monitoring apparatus is further configured to include third information indicating the measured status of the at least one user in the measurement result, and
wherein the server is further configured to:
determine a degree of impatience of the at least one user based on the third information included in the transmitted measurement result; and
calculate the attention degree of the at least one user based on a result of the determination, the first information, and the second information.

16. The computer system according to claim 15,
wherein the monitoring apparatus is further configured to acquire an image indicating the status of the at least one user, and
wherein the third information comprises the acquired image indicating the status of the at least one user.

17. The computer system according to claim 15,
wherein the monitoring apparatus is further configured to measure one of a temperature and a body movement of the at least one user, and
wherein the third information indicates the measured one of the temperature and the body movement of the at least one user.

18. The information processing method according to claim 14, further comprising:
including, by the monitoring apparatus, third information indicating the measured status of the at least one user in the measurement result;
determining, by the server, a degree of impatience of the at least one user based on the third information included in the transmitted measurement result; and
calculating, by the server, the attention degree of the at least one user based on a result of the determination, the first information, and the second information.

19. The information processing method according to claim 18, further comprising acquiring, by the monitoring apparatus, an image indicating the status of the at least one user,
wherein the third information comprises the acquired image indicating the status of the at least one user.

20. The information processing method according to claim 18, further comprising measuring, by the monitoring apparatus, one of a temperature and a body movement of the at least one user,
wherein the third information indicates the measured one of the temperature and the body movement of the at least one user.
